(19) United States
(12) Patent Application Publication
(10) Pub. No.: US 2025/0232316 A1
(43) Pub. Date: Jul. 17, 2025

(54) WELL AND ASSET ANALYSIS WITH AI-DRIVEN SCREENING

(71) Applicant: Schlumberger Technology Corporation, Sugar Land, TX (US)

(72) Inventors: Brandon Cavallaro, London (GB); Karl Staffan Tekin Eriksson, London (GB); Kwangwon Park, Houston, TX (US); Chao Gao, Menlo Park, CA (US); Nikara Pangereyeva, Houston, TX (US); Leandro Ribeiro dos Santos, Houston, TX (US); Melanie Timm, Houston, TX (US)

(21) Appl. No.: 19/021,997

(22) Filed: Jan. 15, 2025

Related U.S. Application Data
(60) Provisional application No. 63/621,468, filed on Jan. 16, 2024.

(51) Int. Cl. G06Q 30/018; G06F 40/40; G06Q 50/02

(52) U.S. Cl. CPC G06Q 30/018; G06F 40/40; G06Q 50/02

(57) ABSTRACT

A method for performing an asset analysis includes receiving first input data for a plurality of first assets. The method also includes building or training a large language model (LLM) based upon the first input data. The method also includes receiving second input data for a plurality of second assets. The method also includes receiving a request to screen one or more of the second assets. The request is to detect an anomaly and/or to improve a performance of one or more of the second assets. The method also includes selecting one or more screening tools using the LLM based upon the request. The method also includes determining an order to apply the one or more selected screening tools based upon the first input data, the second input data, and the request. The method also includes screening one or more of the second assets using the one or more selected screening tools in the order.

### CROSS-REFERENCE TO RELATED APPLICATIONS

This application claims priority to U.S. Provisional Patent Application No. 63/621,468, filed on Jan. 16, 2024, which is incorporated by reference.

### BACKGROUND

A well screener is a tool or system that is used to filter and analyze data from oil and gas wells. The well screener allows users to select specific criteria, such as production levels, downtime, and operating costs, and then return a list of wells that meet those criteria. The well screener can help operators quickly identify wells that may use attention or optimization, and to make data-driven or physics-driven decisions about well performance. This can save users time and effort when searching for and analyzing well data. It can help also them make more informed decisions.

The well screener can include a variety of features, such as the ability to filter data by various parameters, the ability to create custom queries, the ability to view data in various formats, such as graphs and charts, and the ability to export data for further analysis. It may also include features like machine learning algorithms, which can be used to identify patterns and anomalies in the data, and to make predictions about future performance.

Conventional well screeners are most efficiently operated by users with a technical background, particularly in coding or query language. This complexity can be a barrier for users who may have domain expertise but limited technical skills. In addition, manually sifting through large volumes of production data to identify underperforming assets or other specific criteria can be time-consuming. Moreover, conventional well screeners often learn and adapt based on the actions of individual users, which can lead to a narrow, biased perspective in screening. Furthermore, conventional well screeners do not continuously update or optimize their screening processes, which can lead to outdated or less effective workflows over time.

Therefore, what is needed is an improved system and method for screening a reservoir. More particularly, what is needed is an improved system and method for performing an asset analysis with artificial intelligence (AI)-driven screening.

### SUMMARY

A method for performing an asset analysis is disclosed. The method includes receiving first input data for a plurality of first assets. The method also includes building or training a large language model (LLM) based upon the first input data. The method also includes receiving second input data for a plurality of second assets. The method also includes receiving a request to screen one or more of the second assets. The request is to detect an anomaly and/or to improve a performance of one or more of the second assets. The method also includes selecting one or more screening tools using the LLM based upon the request. The method also includes determining an order to apply the one or more selected screening tools based upon the first input data, the second input data, and the request. The method also includes screening one or more of the second assets using the one or more selected screening tools in the order.

In another embodiment, the method may include receiving first input data for a plurality of first assets. The first input data includes time series data, images, production performance, energy consumption, temperature, pressure, flow rate, vibration, speed, water cut, gas-oil ratio, valve or actuator positions, corrosion and/or erosion status, noise levels, radiation levels, tank levels, uptime status, choke settings, or a combination thereof. The first input data also includes training manuals for the first assets, operation manuals for the first assets, maintenance history for the first assets, or a combination thereof. The first assets include one or more wells, compressors, pumps, tanks, separators, production manifolds, artificial lifts, electrical submersible pump, a gas lifts, plunger lifts, rod pump prime movers, or a combination thereof. The method also includes building or training a large language model (LLM) based upon the first input data. The method also includes incorporating the LLM into a system that also includes a plurality of screening tools. The screening tools include a time series anomaly detection tool. The method also includes receiving second input data for the first assets or a plurality of second assets. The second input data is measured after the first input data. The method also includes receiving a request to screen one or more of the first assets and/or one or more of the second assets using one or more of the screening tools. The request is received via a chatbot of the LLM. The request is to detect an anomaly related to one or more of the first assets and/or one or more of the second assets and/or to improve a performance of one or more of the first assets and/or one or more of the second assets. The method also includes selecting one or more of the screening tools using the LLM based upon the request. Selecting the one or more of the screening tools includes interpreting the request. Selecting the one or more of the screening tools also includes classifying the request into a domain-specific methodology. The request is classified after the request is interpreted. Selecting the one or more screening tools also includes selecting the one or more of the screening tools based upon the domain-specific methodology. The one or more screening tools include a first of the one or more screening tools configured to detect the anomaly and/or the performance, a second of the one or more screening tools configured to determine a cause of the anomaly and/or the performance. Selecting the one or more of the screening tools includes a third of the one or more screening tools configured to determine a remedy for the anomaly or optimize the performance, and a fourth of the one or more screening tools configured to predict an outcome after the remedy or optimization is implemented. The prediction involves an economic analysis. The method also includes determining an order to apply the one or more screening tools based upon the first input data, the second input data, and the request. The order is also determined based upon an amount of time, detail, and/or effort to implement the remedy or to optimize the performance, an expense to implement the remedy or to optimize the performance, a type of the remedy or the optimization, a likelihood of a risk of the anomaly, an impact of the remedy, weights, custom rules, or equations to calculate an indicator for the order, or a combination thereof. The method also includes screening one or more of the first assets and/or one or more of the second assets using the one or more selected screening tools in the order. The screening is based upon a combination of rules. The rules dictate that the screening be performed on the wells in a predetermined area, to the wells of a predetermined type, to the compressors above or below predetermined compressor thresholds, or a combination thereof. The method also includes displaying a result of screening. The result includes a ranking of one or more of the first assets and/or one or more of the second assets based upon the anomaly or the performance, the cause of the anomaly or the performance being below a performance threshold, a timeframe and/or expense to implement the remedy or optimization, the predicted outcome after implementing the remedy or the optimization, or a combination thereof. The method also includes performing a wellsite action in response to the result. The wellsite action includes generating and/or transmitting a signal that instructs or causes a physical action to occur. The physical action implements the remedy or the optimization in one or more of the first assets and/or one or more of the second assets. The physical action includes performing setpoint changes, adjusting a speed, adjusting a pressure, adjusting a chemical dosage, or a combination thereof.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for performing an asset analysis with artificial intelligence (AI)-driven screening, according to an embodiment.

FIG. 3 illustrates a screenshot of a query builder, according to an embodiment.

FIGS. 4A-4N illustrate results of the asset analysis, according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

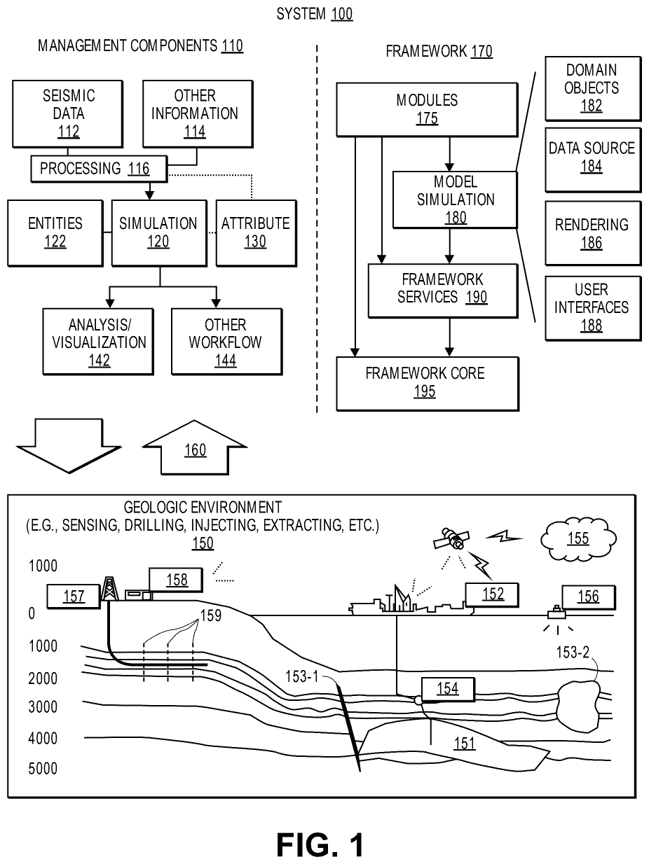

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET© framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Smart Well Screening: Well and Asset Analysis with AI-Driven User-Friendly Screening

The system (e.g., a well screening tool) is an advanced screening tool that enhances user experience through simplicity and intelligence. The tool simplifies the use thereof (i.e., the method), making it more accessible to a wider range of users. The tool makes investment analysis more accessible and efficient.

The tool may include a chatbot feature that streamlines the method, allowing for quick and efficient retrieval of tailored information. The chatbot integration reduces or eliminates the request for technical coding skills, making it easy for users to request specific production data, such as finding underperforming assets. The tool also speeds up the research process, allowing users to quickly access tailored information through simple chatbot commands. By integrating chatbot capabilities, users can easily request specific data, such as finding underperforming assets, without coding complex queries. For example, users can interact with the chatbot to make requests such as: “Find me 3 ESPs that are underperforming,” streamlining the data retrieval process.

The tool's collective learning approach mitigates problems by incorporating a broader range of user behaviors, leading to more comprehensive and unbiased screening outcomes. More particularly, through its collective learning approach, the tool learns from the usage patterns of a plurality of engineers, leading to more balanced and comprehensive screening results. In contrast, conventional screening tools are designed to adapt and learn from the actions of individual users, leading to a narrow optimization path. The tool described herein, however, utilizes a collective learning algorithm that observes and learns from the usage patterns of a plurality of engineers, not just individual ones. This approach allows for a more comprehensive understanding of best practices, leading to more effective and refined screening processes.

The tool may include an automatic back-testing feature that constantly refines and improves the screening process based on historical data. More particularly, automatic back-testing ensures the screening workflows are constantly updated and optimized based on historical data, making the tool more effective over time. This allows for continuous refinement and optimization of screening workflows, ensuring that the tool remains efficient and effective over time. It helps users obtain current data and understand how their strategies would have performed in the past, leading to more informed decision-making. These innovations make the tool not just a data retrieval system, but a comprehensive, self-improving solution for investment analysis, setting it apart from conventional tools.

The tool is easy to use and performs a thorough analysis. The tool speeds up the deferral impact, saving precious time and resources. The tool also incorporates learnings across diverse populations, drawing from both structured and unstructured data sources. This allows for an unparalleled understanding of the root causes of failures, leading to more effective intervention methods. One area that sets the tool apart is its capability for faster prototyping of new screening methods. This means solutions can evolve rapidly, incorporating the latest knowledge and API capabilities for enhanced analysis or data presentation. The tool uniquely indexes API documentation, enabling seamless integration of new data sources and the agility to adapt to changing requests.

Moreover, the tool excels in accelerating the prototyping process. By modifying the prompt layer or prompts, it allows for rapid iteration and refinement. The tool can also auto-propose analysis methods based on a vast training corpus. In other words, doesn't just suggest; it builds the analysis using available tools automatically, turning complex data into actionable insights in a fraction of the time.

### Before Use

The tool may work off a base of production optimization knowledge. It may also or instead be trained on textbooks or other high quality data that is either procured, vetted, and/or quality-controlled (QCed). The tool may include a base model with benchmarks. The tool may use question-answer pairs from support tickets. The tool may also use reinforcement learning from human feedback (RLHF) and/or continuous feedback from domain experts to further align outcomes.

The tool may also use knowledge about the asset population and historical interventions in the population either through: (1) a fine-tuned base model or embeddings, and/or (2) RAG extension with appropriate syntax abstraction layer—to enable access to live data from the assets.

The tool may also use an API index and/or catalogue with appropriate (1) function calls (e.g., calculate X, domain specific calculations), (2) machine-learning (ML) models (e.g., data driven inference from a targeted dataset), and/or (3) user interface components to which results can be served (e.g., graphs, text, or images).

The tool may include a prompt database with tested and validated methods for querying and combining knowledge with data and functions. More particularly, the tool may include a user interface (UI) layer for presenting results and receiving commands. For example, this may include a text interface or a pre-curated set of functions and/or commands via UI controls.

The tool may also use an LLM as an orchestrator of systems of engagement (UI), systems of record (e.g., databases), and tools/skills (e.g., functions, microservices, simulators, LLMs, etc.). In an embodiment, the tool may use a hierarchy of LLMs (e.g., in a ReAct configuration, with smaller LLMs at lower levels). In another embodiment, the tool may include multi-modal capabilities (e.g., beyond text).

### Tool Uses

The tool may query the system for data for a specific asset class, and provide results on a screen using graphical components, charts, and/or images. The tool may receive and answer general questions about population, ideas for optimization, data quality, anomalies, etc. For example, a user may ask the tool to perform a specific analysis on a specific asset class (e.g., LLM constructs queries to fetch data and then passes to the correct APIs to be presented on a screen). In another example, a user may ask the tool to apply a hierarchy of screening methods on selected assets. The tool may use less computationally heavy or coarser methods first, and the tool may know when to use more detailed methods. The tool may also or instead address common problems with population. For example, base screening for opportunities may be based on earlier success or old tickets by looking at similarities between assets. In another example, there may be automated calling of screening tools.

A user may also ask the tool to perform automated screening across a population periodically or trigger-based. The tool may change the objective function for opportunity selection. The tool may also or instead change the temperature of LLM or weights in an evaluation. The tool may also or instead look for other opportunities (e.g., by weighing certain lessons more than others). The tool may also or instead look at/for specific challenges. The tool may also or instead be configured to receive or use a constraint, time, compute resources, etc. that may maximize the use of the tool.

In another example, a user may ask the tool to suggest new screening methods based on available knowledge (e.g., domain or new data from assets) or external triggers. The tool may capture domain user feedback through an interface (e.g., weighing and/or evaluating results of an analysis).

### Tool Benefits

The tool may provide ease of use, thoroughness of analysis, and speed (e.g., deferral impact). The tool may also or instead incorporate learnings across a population and/or from unstructured data sources. The tool may use intervention methods as well as knowledge about root causes of failure. The tool may provide faster prototyping of new screening methods, leading to rapidly evolving solutions. The tool may include new knowledge. The tool may also or instead include new API capabilities for analysis or data presentation by letting the LLM index the API documentation. The tool may include new data sources dynamically. The tool may provide faster prototyping by modifying prompt layer or prompts. The tool may provide an auto proposal of an analysis method from a training corpus and build the analysis using available tools automatically.

### Additional Information

The LLM may be updated with a foundational performance or fine-tuned on specific data related to production operations. The LLM may have access to local procedures, local manuals, or specific instructions about local datasets and asset classes in the form of knowledge, indexed, or in context. This may be in the form of specific instructions designed by experts to help the LLM make better decisions, again containing differentiated domain knowledge. The LLM may have access to databases containing production information about select assets (e.g., timeseries data, metadata about assets, and/or connections to other databases). The LLM may have access to screening tools for production assets. These have different properties and may be applied to solve different problems. For example, some are quick and designed for quick screening, while others involve access to a lot of information and are more expensive to run. In an embodiment, a user can deploy this set of screening tools and may decide when to take specific actions. The LLM may be leveraged in the form of an agent that has been defined in above. The user can now instruct it either through language or other means to carry out a specific action. This can be in domain language, as the screening agent understands domain language, and understands the capabilities that exist as part of the screener toolbox. The screening agent also knows where to search for more information.

In an example, a user may instruct the agent to search across multiple assets and find the top opportunities for intervention. This be through a chat interface, on a specific time interval, and/or by an external signal through an API. The agent may then decide what screening method to apply depending on the assets, the request/instruction, history of screening, and/or a shortlist of the assets that are of interest. These may then be selected for deeper analysis. Using information from local procedures or other databases, other screening methods may be selected by the system depending on the goal. The LLM may then reply and show the output of the analysis back to the user.

Managing by exception in oil and gas production operations involves identifying and prioritizing anomalies, deviations, or conditions in vast operational data from various entities or equipment in the fields, such as well, pad, compressor, pump, artificial lift, wellhead, chokes, and so on. Conventional methods often rely on predefined thresholds or rules, which can result in missed or misclassified exceptions due to their static nature. The method herein addresses these limitations by incorporating an LLM, which dynamically adapts to context and learns from historical data to refine the exception management process.

The method involves data ingestion and contextualization. More particularly, the method may integrate operational data from multiple sources, such as sensors, digital twins, and enterprise databases. The method may also involve LLM Integration. The LLM may be trained on domain-specific data to interpret, contextualize, and rank exceptions. The method may also involve dynamic screening. More particularly, the LLM may screen and rank operational anomalies based on severity, impact, and urgency. The method may also involve a natural language interface. For example, an operator may interact through a conversational interface, querying exceptions and receiving recommendations in real-time. The method may also involve continuous improvement. More particularly, the method may learn from operator feedback and update the LLM's understanding for improved future performance.

An example screening process may include (1) data collection and/or contextualization, (2) anomaly detection using predefined rules or ML models, (3) identified anomalies are passed to the LLM for contextual ranking and explanation, (4) the LLM outputs a prioritized list of exceptions with justifications, and/or (5) operators engage via the interface to refine actions or provide feedback.

### Domain Example: Underperforming Well Optimization

The issue may be that a well is producing below its potential production (e.g., due to declining pressure). A recommended action may be to increase the gas lift injection rate and/or schedule a well stimulation operation. The LLM contribution may be or include provide a ranked list of underperforming wells, determine causes of the decline, suggest potential optimization, and/or predict outcomes for each intervention

### Domain Example: Equipment Malfunction or Failure

The issue may be an anomaly in ESP energy consumption, which suggests a malfunction. The recommended action may be to schedule an inspection or replace the ESP. The LLM contribution may be or include analyzing operational trends, predict the likelihood of equipment failure, and/or suggest maintenance windows to minimize downtime.

### Domain Example: Flow Assurance Challenges

The issue may be wax or hydrate formation in the pipeline (e.g., due to lower temperatures). The recommended action may be to increase the pipeline temperature and/or inject inhibitors to address flow assurance risks. The LLM contribution may be or include recommending inhibitor types and injection rates and/or suggesting operation changes such as increasing throughput to avoid deposition

### Domain Example: Predictive Maintenance

The issue may be the detection of an anomaly in motor vibration in a pump. The recommended action may be to schedule maintenance to prevent failure and/or reduce unplanned downtime. The LLM contribution may be to predict failure timelines and/or recommend an optimal maintenance schedule.

### Exemplary Method

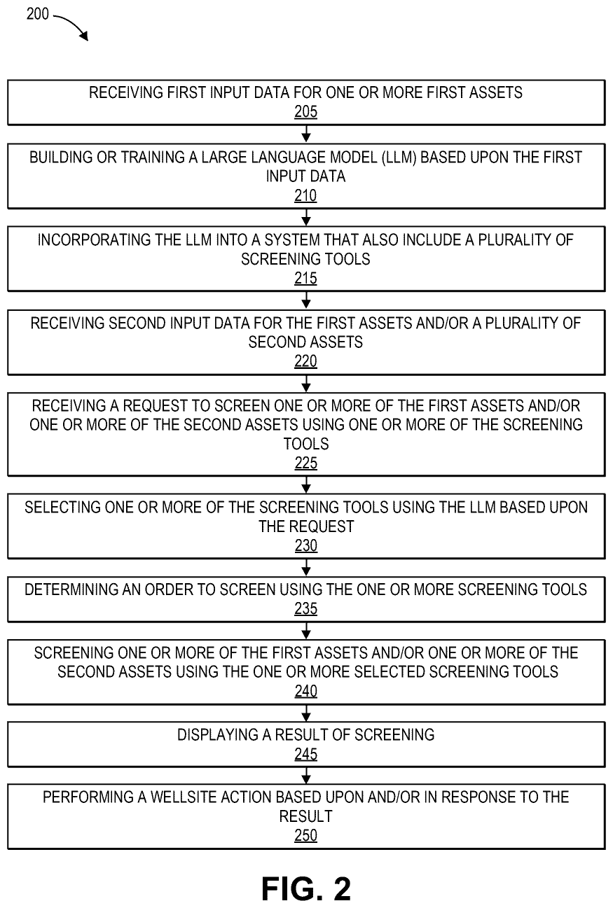

FIG. 2 illustrates a flowchart of the method 200 for performing an asset analysis with artificial intelligence (AI)-driven screening, according to an embodiment. An illustrative order of the method 200 is provided below; however, one or more portions of the method 200 may be performed in a different order, simultaneously, repeated, or omitted. At least a portion of the method 200 may be performed with a computing system (described below).

The method 200 may include receiving first input data for one or more first assets, as at 205. The first input data may be or include time series data, images, production performance, energy consumption, temperature, pressure, flow rate, vibration, speed, water cut, gas-oil ratio, valve or actuator positions, corrosion and/or erosion status, noise levels, radiation levels, tank levels, uptime status, choke settings, or a combination thereof. The first input data may also include training manuals for the first assets, operation manuals for the first assets, maintenance history for the first assets, or a combination thereof. The first assets may be or include one or more wells, compressors, pumps, tanks, separators, production manifolds, artificial lifts, electrical submersible pump, a gas lifts, plunger lifts, rod pump prime movers, or a combination thereof.

The method 200 may also include building or training a large language model (LLM) based upon the first input data, as at 210.

The method 200 may also include incorporating the LLM into a system that also comprises a plurality of screening tools, as at 215. In an example, the screening tools may be or include a time series anomaly detection tool.

The method 200 may also include receiving second input data for the first assets and/or a plurality of second assets, as at 220. The second input data may be measured after the first input data.

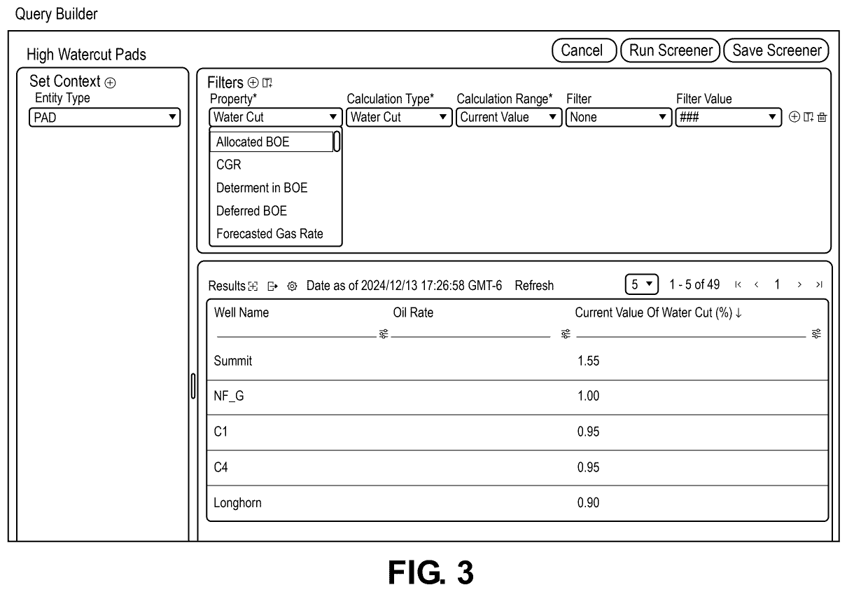

The method 200 may also include receiving a request (also referred to as a query) to screen one or more of the first assets and/or one or more of the second assets using one or more of the screening tools, as at 225. FIG. 3 illustrates a screenshot of a query builder, according to an embodiment. The request may be received via a chatbot of the LLM. The request may be to detect an anomaly related to one or more of the first assets and/or one or more of the second assets and/or to improve the performance of one or more of the first assets and/or one or more of the second assets.

One example of a request may include an operator utilizing the chatbot (e.g., during midstream operations) to determine one or more particular oil wells that have one or more periods of downtime during particular timeframes (e.g., hours, days, weeks, months, quarters, years, etc.). Another example of a request may include an operator utilizing the chatbot (e.g., during midstream operations) to determine one or more particular oil wells that have the highest operating cost or unit production cost during particular timeframes (e.g., hours, days, weeks, months, quarters, years, etc.). Another example of a request may include an operator utilizing the chatbot (e.g., during midstream operations) to determine one or more particular oil wells that have the lowest production during particular timeframes (e.g., hours, days, weeks, months, quarters, years, etc.). Another example of a request may include an operator utilizing the chatbot (e.g., during midstream operations) to determine one or more particular oil wells that have the highest water cut during particular timeframes (e.g., hours, days, weeks, months, quarters, years, etc.). Another example of a request may include an operator utilizing the chatbot (e.g., during midstream operations) to determine one or more particular oil wells that have the highest pressure drop during particular timeframes (e.g., hours, days, weeks, months, quarters, years, etc.). Another example of a request may include an operator utilizing the chatbot (e.g., during midstream operations) to determine one or more particular oil wells that have not reported data during particular timeframes (e.g., days, weeks, months, quarters, years, etc.). Another example of a request may include an operator utilizing the chatbot (e.g., during midstream operations) to determine one or more particular oil wells that have exceeded their maximum allowed temperature during particular timeframes (e.g., days, weeks, months, quarters, years, etc.). Another example of a request may include an operator utilizing the chatbot (e.g., during midstream operations) to determine one or more particular oil wells that have the highest difference in oil rate between the previous well test and the current well test. Another example of a request may include an operator utilizing the chatbot (e.g., during midstream operations) to determine one or more particular oil wells that have the highest shortfall during particular timeframes (e.g., days, weeks, months, quarters, years, etc.). Another example of a request may include an operator utilizing the chatbot (e.g., during midstream operations) to determine one or more particular oil wells that have the highest difference between 7 d and 30 d average.

The method 200 may also include selecting one or more of the screening tools using the LLM based upon the request, as at 230. Selecting the one or more of the screening tools may include interpreting the request. Selecting the one or more of the screening tools may also include classifying the request into a domain-specific methodology. The request may be classified after the request is interpreted. Selecting the one or more of the screening tools may also include selecting the one or more of the screening tools based upon the domain-specific methodology.

The one or more screening tools may be or include a first of the one or more screening tools that is configured to detect the anomaly and/or the performance. The one or more screening tools may also or instead be or include a second of the one or more screening tools that is configured to determine a cause of the anomaly and/or the performance. The one or more screening tools may also or instead be or include a third of the one or more screening tools that is configured to determine a remedy for the anomaly or optimize (e.g., improve) the performance. The one or more screening tools may also or instead be or include a fourth of the one or more screening tools that is configured to predict an outcome after the remedy or optimization is implemented. The prediction may be or include an economic analysis.

The method 200 may also include determining an order to screen one or more of the first assets and/or one or more of the second assets using the one or more screening tools, as at 235. The order may be based upon the first input data, the second input data, and/or the request. The order may also or instead be determined based upon an amount of time, detail, and/or effort to implement the remedy or to optimize the performance, an expense to implement the remedy or to optimize the performance, a type of the remedy or the optimization, a likelihood of a risk of the anomaly, an impact of the remedy, weights, custom rules, or equations to calculate an indicator for the order, or a combination thereof.

The method 200 may also include screening one or more of the first assets and/or one or more of the second assets using the one or more selected screening tools, as at 240. The screening may be performed in the order. The screening may be based upon a combination of rules. In an example, the rules may dictate that the screening occur to the wells in a predetermined area, to the wells of a predetermined type, to the compressors above or below predetermined compressor thresholds, or a combination thereof.

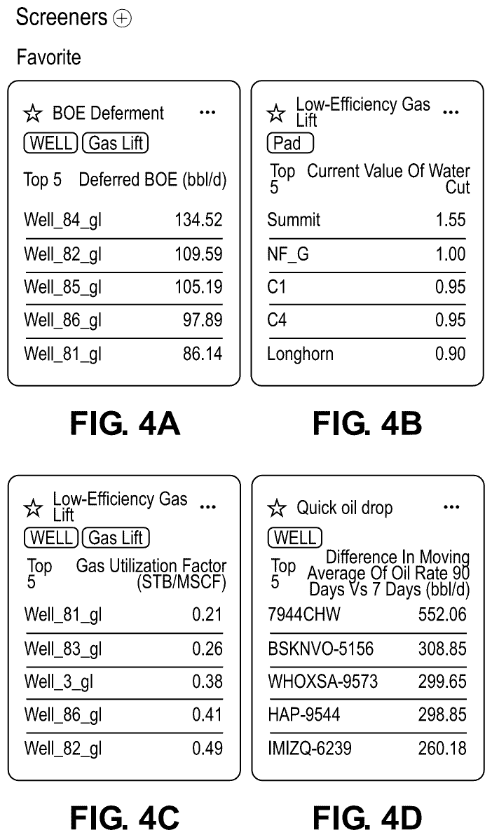

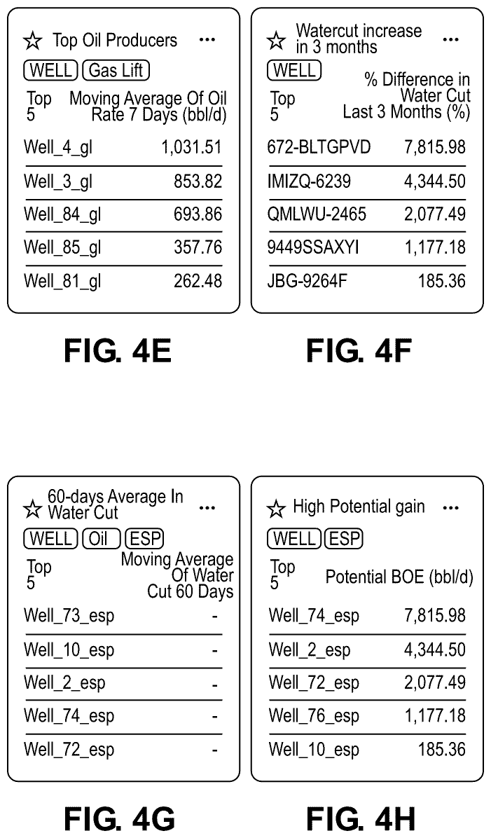

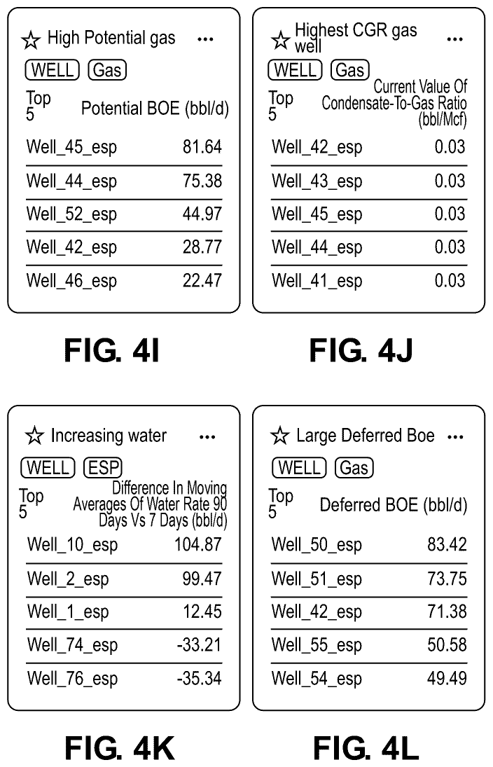

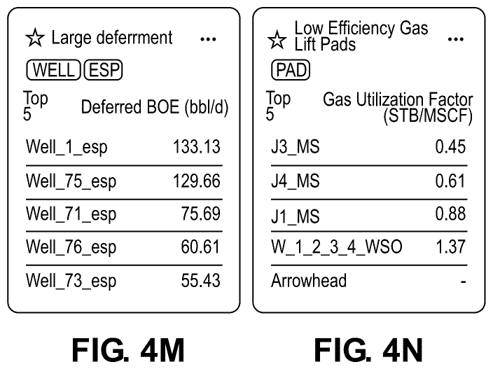

The method 200 may also include displaying a result of screening, as at 245. FIGS. 4A-4N illustrate results of the screening, according to an embodiment. The result may be or include a ranking of one or more of the first assets and/or one or more of the second assets based upon the anomaly or the performance, the cause of the anomaly or the performance being below a performance threshold, the time and/or expense to implement the remedy or optimization, the predicted outcome after implementing the remedy or the optimization, or a combination thereof.

The method 200 may also include performing a wellsite action based upon and/or in response to the result, as at 250. The wellsite action may be or include generating and/or transmitting a signal that instructs or causes a physical action to occur. The physical action implements the remedy or the optimization in one or more of the first assets and/or one or more of the second assets. In one example, the physical action may be or include performing setpoint changes, adjusting a speed, adjusting the pressure, adjusting a chemical dosage, or a combination thereof. In another example, the physical action may be or include selecting where to drill the wells, drilling the wells, varying a weight and/or torque on a drill bit that is drilling the wells, varying a drilling trajectory of the wells, varying a concentration and/or flow rate of a fluid pumped into the wells, or the like.

The method 200 may be able to access and query data stored in the CDF platform, including well data, production data, and sensor data. The method 200 may provide a user-friendly interface for building and executing queries, such as a visual query builder or a scripting language. The method 200 may support advanced filtering capabilities, such as the ability to filter by well attributes, production parameters, and sensor measurements. The method 200 may support aggregation functions, such as sum, average, and count, to allow for the analysis of large sets of data. The method 200 may support data visualization to allow users to easily interpret the results of their queries. For example, the display may include a tabular view, top wells summary, charts to show number of wells screened, timeseries trend charts, etc. The method 200 may support the ability to save and reuse frequently used queries, to save time and increase efficiency. Queries can be saved for the user. Queries can be shared with other users. This may start with two tags: my query or public query. The method 200 may be able to export query results in a variety of formats, such as CSV, JSON, or Excel, to allow for further analysis and reporting. The method 200 may provide appropriate security and access controls, such as authentication and authorization, to ensure authorized users can access and query the data. The method 200 may be able to handle large data sets and able to process the data in real-time or near-real-time.

The method 200 may improve data discovery. More particularly, the query builder allows a user to easily search through large amounts of data and filter it based on specific criteria, making it easier to find and analyze the desired data. The method 200 also provides improved efficiency. With the method 200, the user can quickly and easily identify specific wells or groups of wells that meet certain criteria, without having to manually sift through the data. The method 200 may provide better data visualization. By using the query builder, the user can create visualizations that are tailored to specific requests, which can make it easier to identify patterns, trends, and insights in the data. The method 200 may also provide advanced data analysis. The query builder allows for complex queries that can be used for advanced data analysis, such pattern recognition, anomaly detection, or predictive modelling. The method 200 may also enable better collaboration. The query builder allows multiple users to work on the same dataset and share their queries, which can improve collaboration and communication within a team.

### Exemplary Computing System

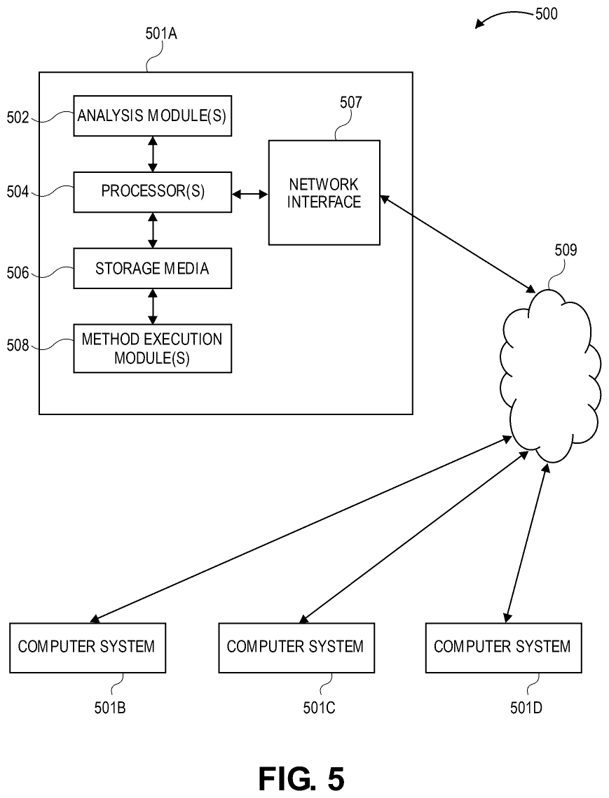

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more screening module(s) 508. In the example of computing system 500, computer system 501A includes the screening module 508. In some embodiments, a single screening module may be used to perform some aspects of one or more embodiments of the methods disclosed herein. In other embodiments, a plurality of screening modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for performing an asset analysis, the method comprising:
receiving first input data for a plurality of first assets;
building or training a large language model (LLM) based upon the first input data;
receiving second input data for a plurality of second assets;
receiving a request to screen one or more of the second assets, wherein the request is to detect an anomaly and/or to improve a performance of one or more of the second assets;
selecting one or more screening tools using the LLM based upon the request;
determining an order to apply the one or more selected screening tools based upon the first input data, the second input data, and the request; and
screening one or more of the second assets using the one or more selected screening tools in the order.

2. The method of claim 1, wherein the first input data comprises time series data, images, production performance, energy consumption, temperature, pressure, flow rate, vibration, speed, water cut, gas-oil ratio, valve or actuator positions, corrosion and/or erosion status, noise levels, radiation levels, tank levels, uptime status, choke settings, or a combination thereof, and wherein the first input data also comprises training manuals for the first assets, operation manuals for the first assets, maintenance history for the first assets, or a combination thereof.

3. The method of claim 1, wherein the first assets comprise one or more wells, compressors, pumps, tanks, separators, production manifolds, artificial lifts, electrical submersible pump, a gas lifts, plunger lifts, rod pump prime movers, or a combination thereof.

4. The method of claim 1, wherein selecting the one or more screening tools comprises:
interpreting the request;
classifying the request into a domain-specific methodology, wherein the request is classified after the request is interpreted; and
selecting the one or more screening tools based upon the domain-specific methodology.

5. The method of claim 1, wherein the one or more screening tools comprise:
a first of the one or more screening tools configured to detect the anomaly and/or the performance;
a second of the one or more screening tools configured to determine a cause of the anomaly and/or the performance;
a third of the one or more screening tools configured to determine a remedy for the anomaly and/or improve the performance; and
a fourth of the one or more screening tools configured to predict an outcome after the remedy and/or improvement is implemented, wherein the prediction comprises an economic analysis.

6. The method of claim 1, wherein the order is also determined based upon an amount of time, detail, and/or effort to implement the remedy and/or to improve the performance, an expense to implement the remedy and/or to improve the performance, a type of the remedy or the improvement, a likelihood of a risk of the anomaly, an impact of the remedy, weights, custom rules, or equations to calculate an indicator for the order, or a combination thereof.

7. The method of claim 1, wherein the screening is based upon a combination of rules, and wherein the rules dictate that the screening be performed for wells in a predetermined area, to the wells of a predetermined type, to compressors above or below predetermined compressor thresholds, or a combination thereof.

8. The method of claim 1, further comprising displaying a result of screening, wherein the result comprises a ranking of one or more of the second assets based upon the anomaly and/or the performance, the cause of the anomaly and/or the performance being below a performance threshold, a timeframe and/or expense to implement the remedy or improvement, the predicted outcome after implementing the remedy or the improvement, or a combination thereof.

9. The method of claim 8, further comprising performing a wellsite action in response to the result, wherein the wellsite action comprises generating and/or transmitting a signal that instructs or causes a physical action to occur.

10. The method of claim 9, wherein the physical action improves the performance in one or more of the second assets, and wherein the physical action comprises performing setpoint changes, adjusting a speed, adjusting a pressure, adjusting a chemical dosage, or a combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
receiving first input data for a plurality of first assets;
building or training a large language model (LLM) based upon the first input data;
receiving second input data for a plurality of second assets;
receiving a request to screen one or more of the second assets, wherein the request is to detect an anomaly and/or to improve a performance of one or more of the second assets;
selecting one or more screening tools using the LLM based upon the request;
determining an order to apply the one or more selected screening tools based upon the first input data, the second input data, and the request; and
screening one or more of the second assets using the one or more selected screening tools in the order.

12. The computing system of claim 11, wherein the first input data comprises time series data, images, production performance, energy consumption, temperature, pressure, flow rate, vibration, speed, water cut, gas-oil ratio, valve or actuator positions, corrosion and/or erosion status, noise levels, radiation levels, tank levels, uptime status, choke settings, or a combination thereof, and wherein the first input data also comprises training manuals for the first assets, operation manuals for the first assets, maintenance history for the first assets, or a combination thereof.

13. The computing system of claim 12, wherein the first assets comprise one or more wells, compressors, pumps, tanks, separators, production manifolds, artificial lifts, electrical submersible pump, a gas lifts, plunger lifts, rod pump prime movers, or a combination thereof.

14. The computing system of claim 13, wherein the one or more screening tools comprise a time series anomaly detection tool.

15. The computing system of claim 14, wherein the request is received via a chatbot of the LLM.

16. A non-transitory computer-readable medium storing instructions that, when executed by one or more processors of a computing system, cause the computing system to perform operations, the operations comprising:
receiving first input data for a plurality of first assets;
building or training a large language model (LLM) based upon the first input data;
receiving second input data for a plurality of second assets;
receiving a request to screen one or more of the second assets, wherein the request is to detect an anomaly and/or to improve a performance of one or more of the second assets;
selecting one or more screening tools using the LLM based upon the request;
determining an order to apply the one or more selected screening tools based upon the first input data, the second input data, and the request; and
screening one or more of the second assets using the one or more selected screening tools in the order.

17. The non-transitory computer-readable medium of claim 16, wherein selecting the one or more screening tools comprises:
interpreting the request;
classifying the request into a domain-specific methodology, wherein the request is classified after the request is interpreted; and
selecting the one or more screening tools based upon the domain-specific methodology, wherein the one or more screening tools comprise:
a first of the one or more screening tools configured to detect the anomaly and/or measure the performance;
a second of the one or more screening tools configured to determine a cause of the anomaly and/or the performance;
a third of the one or more screening tools configured to determine a remedy for the anomaly or improve the performance; and
a fourth of the one or more screening tools configured to predict an outcome after the remedy or improvement is implemented, wherein the prediction comprises an economic analysis.

18. The non-transitory computer-readable medium of claim 17, wherein the order is also determined based upon an amount of time, detail, and/or effort to implement the remedy or to improve the performance, an expense to implement the remedy or to improve the performance, a type of the remedy or the improvement, a likelihood of a risk of the anomaly, an impact of the remedy, and weights, custom rules, or equations to calculate an indicator for the order.

19. The non-transitory computer-readable medium of claim 18, wherein the screening is based upon a combination of rules, and wherein the rules dictate that the screening be performed for wells in a predetermined area, to the wells of a predetermined type, to compressors above or below predetermined compressor thresholds, or a combination thereof.

20. The non-transitory computer-readable medium of claim 19, wherein the operations further comprise:
displaying a result of screening, wherein the result comprises a ranking of one or more of the second assets based upon the anomaly or the performance, the cause of the anomaly or the performance being below a performance threshold, a timeframe and/or expense to implement the remedy or improvement, and the predicted outcome after implementing the remedy or the improvement; and
performing a wellsite action in response to the result, wherein the wellsite action comprises generating and/or transmitting a signal that instructs or causes a physical action to occur, wherein the physical action implements the remedy or the improvement in one or more of the second assets, and wherein the physical action comprises performing setpoint changes, adjusting a speed, adjusting a pressure, adjusting a chemical dosage, or a combination thereof.
